(19) United States
(12) Patent Application Publication
(10) Pub. No.: US 2004/0065176 A1
(43) Pub. Date: Apr. 8, 2004

(54) Magnetic socket wrench assembly

(76) Inventor: Jan-Shing Lin, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/371,635

(22) Filed: Feb. 20, 2003

(30) Foreign Application Priority Data
Oct. 8, 2002 (TW) 91123216

(51) Int. Cl. B25B 13/02

(52) U.S. Cl. 81/125

(57) ABSTRACT

A magnetic socket wrench assembly includes a tubular wrench body, an annular mounting member, and a plurality of magnets. The wrench body is adapted to be connected to a tool, and has a central hole that includes a shank-receiving narrow hole portion and a socket-defining wide hole portion, which receives the mounting member fixedly and which engages a nut to be rotated on a bolt. The mounting member has a nut-engaging end surface with a plurality of magnet-receiving holes for receiving the magnets fixedly. When engaging the nut, the bolt can extend through the mounting member and into the narrow hole portion.

### CROSS-REFERENCE TO RELATED APPLICATION

This application claims priority of Taiwanese Application No. 091123216, filed on Oct. 8, 2002.

### BACKGROUND OF THE INVENTION

1. Field of the Invention

The invention relates to a magnetic socket wrench assembly, more particularly to a magnetic socket wrench assembly that includes a plurality of magnets, which are mounted therein by means of an annular mounting member.

2. Description of the Related Art

Referring to FIG. 1, a first conventional magnetic socket wrench assembly 1 is shown to comprise a tubular wrench body 12 having a groove 11, a non-magnetic unit 13, and a magnet 15 that is disposed inside the non-magnetic unit 13 and that has an outer end portion slightly protruding out of an outer end surface 14 of the non-magnetic unit 13.

Referring to FIG. 2, a second conventional magnetic socket wrench assembly 2 disclosed in U.S. Pat. No. 5,146,814 is shown to include a tubular wrench body 21, a non-magnetic compressible disk 22, and a ceramic magnet 23 secured to a lower portion of the disk 22.

Referring to FIG. 3, a third conventional magnetic socket wrench assembly 3 disclosed in U.S. Pat. No. 5,542,320 is shown to include a tubular wrench body 31, a non-magnetic compressible disk 32 formed with a recess 321, and a cylindrical magnet 33. The magnet 33 is received in the recess 321 and is secured to the disk 32 by means of a layer 36 having a size larger than and extending over a face 331 of the magnet 33 and integrally secured around its entire periphery to a lower portion 322 of the disk 32.

Although each of the above-mentioned conventional magnetic socket wrench assemblies 1, 2, 3 includes a magnet 15, 23, 33 to magnetically retain a nut on the assembly 1, 2, 3 during fastening or removal of the nut, in actual use, the conventional magnetic socket wrench assemblies 1, 2, 3 were found to have the following disadvantage:

Referring to FIG. 4, the third conventional magnetic socket wrench assembly 3 is used as an example for rotating a nut 37 on a bolt 38. When the nut 37 is fastened to the bolt 38 having a relatively long shank portion, the wrench body 31 can be selected so as to have an increased height (D), thereby attaining its intended purpose. However, the distance between the magnet 33 and the nut 37 is too long to attract the latter on the former. As such, when the removal or fastening of the nut 37 is performed in a deeper or narrower working environment, since the magnet 33 cannot be used to magnetically retain the nut 37 on the wrench assembly 3, the nut 37 is likely to drop, and is thus difficult to retrieve.

### SUMMARY OF THE INVENTION

Therefore, the main object of the present invention is to provide a magnetic socket wrench assembly that is capable of overcoming the aforementioned drawback of the prior art.

According to the present invention, a magnetic socket wrench assembly is adapted to be connected removably to a tool for rotating a nut on a bolt, and comprises a tubular wrench body, an annular mounting member, and a plurality of magnets. The wrench body is adapted to be connected to the tool, and has a central hole that includes a shank-receiving narrow hole portion adapted for extension of a shank of the bolt thereinto, and a socket-defining wide hole portion, which is wider than the narrow hole portion, which is adapted to engage the nut, and which defines a shoulder between the narrow and wide hole portions. The mounting member is disposed fixedly in the wide hole portion of the central hole in the wrench body, and abuts against the shoulder. The mounting member has a central hole formed therethrough and adapted for extension of the shank of the bolt therethrough, and a nut-engaging end surface which is adapted to abut against the nut and which is formed with a plurality of magnet-receiving holes. The magnets are disposed respectively in the holes in the mounting member, and are adapted for magnetically attracting the nut.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a first conventional magnetic socket wrench assembly;

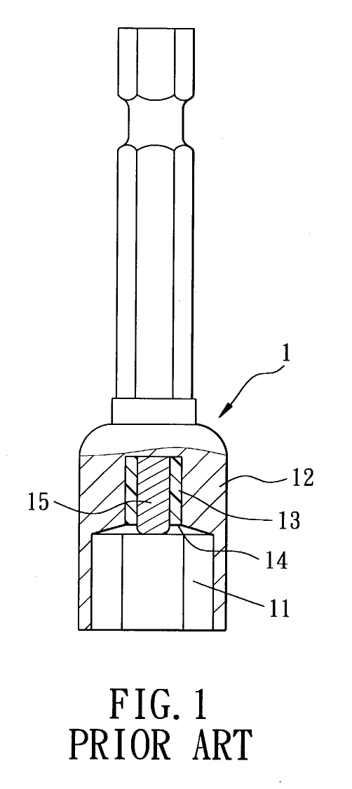

FIG. 2 is a sectional view of a second conventional magnetic socket wrench assembly;

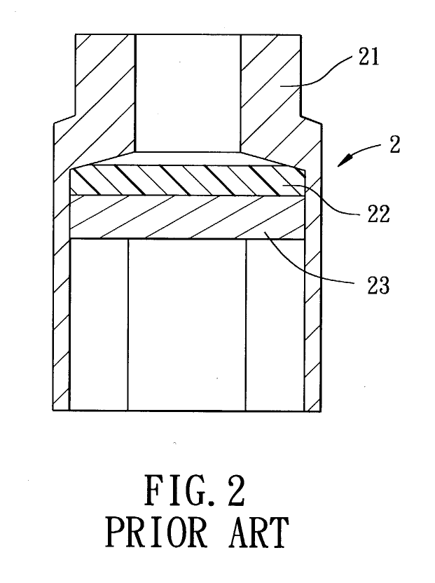

FIG. 3 is a sectional view of a third conventional magnetic socket wrench assembly;

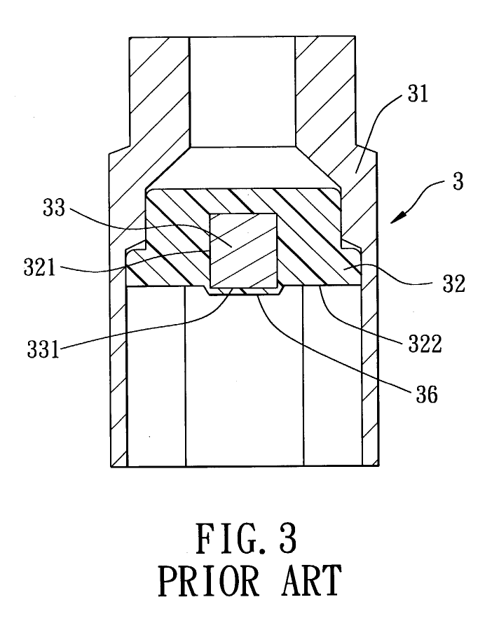

FIG. 4 is a sectional view of the third conventional magnetic socket wrench assembly in a state of use;

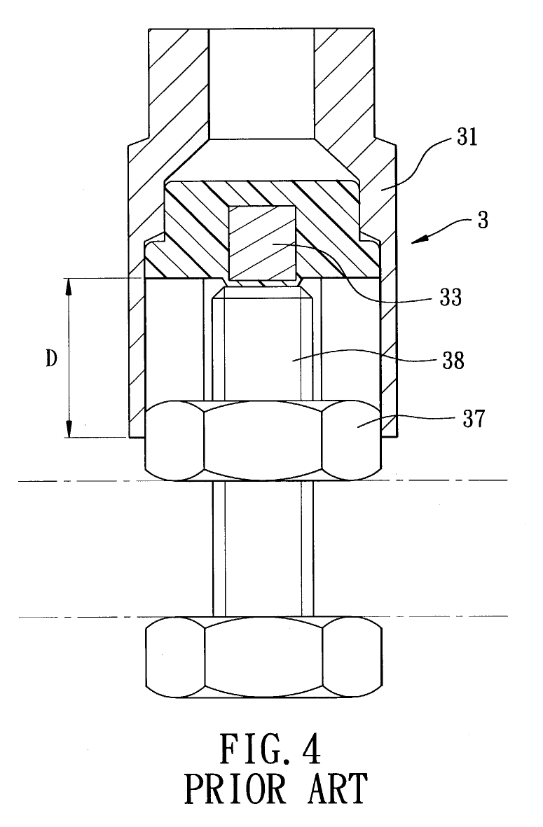

FIG. 5 is an exploded perspective of the first preferred embodiment of a magnetic socket wrench assembly according to the present invention;

FIG. 6 is a sectional view of the first preferred embodiment in an assembled state;

FIG. 7 is a sectional view of the first preferred embodiment in a state of use;

FIG. 8 is a sectional view of the first preferred embodiment in another state of use; and

FIG. 9 is a sectional view of the second preferred embodiment of a magnetic socket wrench assembly according to the present invention, illustrating the second preferred embodiment in a state of use.

### DETAILED DESCRIPTION OF THE PREFERRED EMBODIMENT

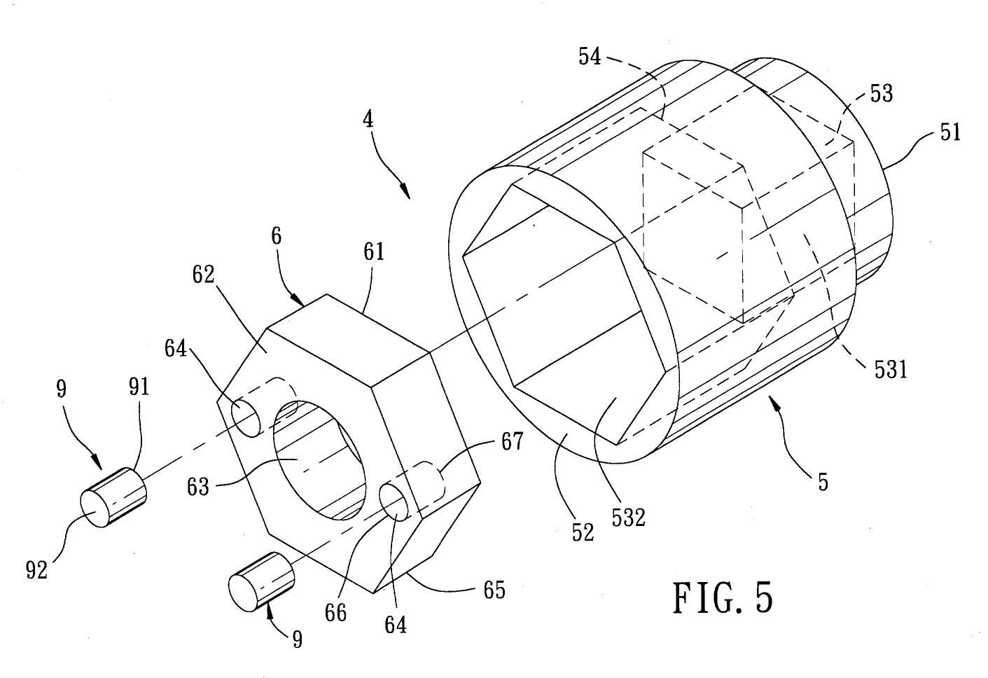

Referring to FIGS. 5 to 8, the first preferred embodiment of a magnetic socket wrench assembly 4 according to the present invention is adapted to be connected removably to a tool 10 for rotating a nut 8 on a bolt 81 or for rotating a screw bolt 7, and is shown to comprise a tubular wrench body 5, an annular mounting member 6, and a magnet unit.

The tubular wrench body 5 is adapted to be connected to the tool 10, which can be a hand tool or a pneumatic tool, and has opposite first and second end surfaces 51, 52, and a central hole 53 that extends from the first end surface 51 to the second end surface 52 and that includes a shank-receiving narrow hole portion 531 adapted for extension of a shank of the bolt 81 thereinto, and a socket-defining wide hole portion 532, which is wider than the narrow hole portion 531, which has a polygonal cross-section so as to be adapted to engage the nut 8, and which defines a shoulder 54 between the narrow and wide hole portions 531, 532.

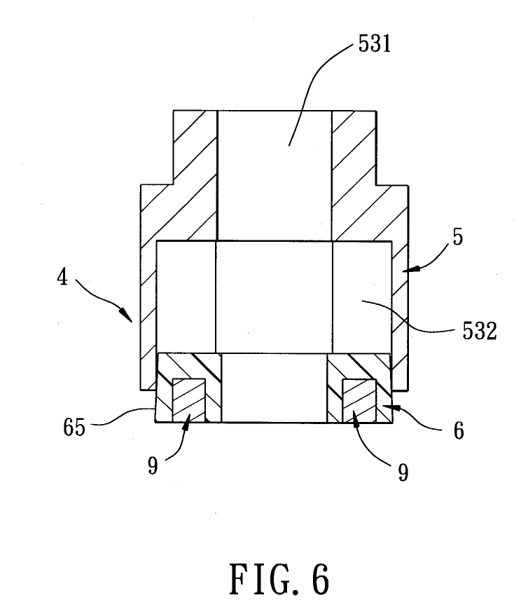

The annular mounting member 6 is disposed fixedly in the wide hole portion 532 of the central hole 53 in the wrench body 5, and is made of a non-magnetic, compressible material. In this embodiment, the mounting member is made of aplastic material. The mounting member 6 has a central hole 63 formed therethrough and adapted for extension of the shank of the bolt 81 therethrough, an abutment surface 61 abutting against the shoulder 54 of the wrench body 5, and a nut-engaging end surface 62, which is opposite to the abutment surface 61, which is adapted to abut against the nut 8, and which is formed with a magnet-receiving hole unit therein. The magnet-receiving hole unit includes a pair of diametrically opposed magnet-receiving holes 64. Each of the magnet-receiving holes 64 has an open end 66 and a closed end 67. The mounting member 6 further has a tapered annular outer surface 65 (see FIG. 6) that has a maximum size slightly greater than that of the wide hole portion 532 of the central hole 53 in the wrench body 5 and that has a minimum size slightly smaller than that of the wide hole portion 532 of the central hole 53 in the wrench body 5 so that the mounting member 6 can be press-fitted within the wide hole portion 532 of the central hole 53 in the wrench body 5 during assembly.

The magnet unit includes a pair of magnets 9 disposed respectively in the magnet-receiving holes 64 in the mounting member 6, are fixed therein by means of an adhesive, and are adapted for magnetically attracting the nut 8. Each of the magnets 9 has an inner end surface 91 that is disposed at the closed end 67 of the respective one of the magnet-receiving holes 64, and an outer end surface 92 that is flush with the nut-engaging end surface 62 of the mounting member 6.

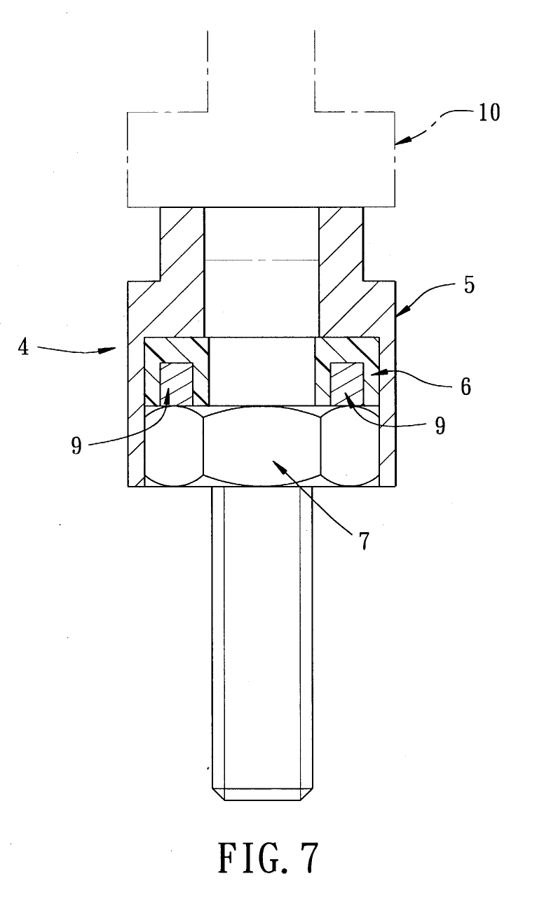

In use, referring to FIG. 7, after the magnetic socket wrench assembly 4 is connected to the tool 10, the wrench body 5 can be sleeved on a head portion of the screw bolt 7 to proceed with the fastening or removal of the screw bolt 7. At this time, the head portion of the screw bolt 7 is in direct contact with the magnets 9 in the mounting member 6. Then, the screw bolt 7 is rotated so as to be loosened from or fastened to a fastening location. Since the screw bolt 7 is magnetically attached to the mounting member 6, it is not likely to drop from the latter, and can be easily removed from or fastened to the fastening location.

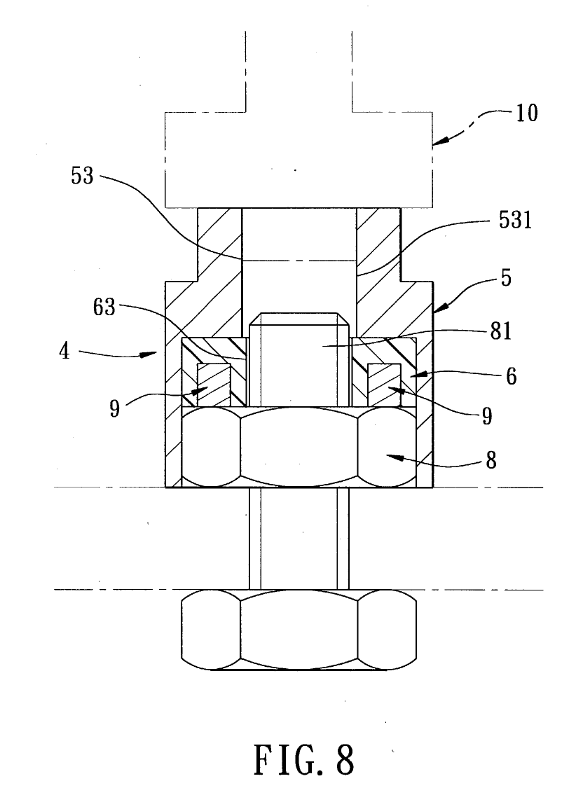

Referring to FIG. 8, when the nut 8 is threadedly secured on a long threaded shank portion of the bolt 81, the shank portion of the bolt 81 can pass through the hole 63 in the mounting member 6, and into the narrow hole portion 531 of the central hole 53 in the wrench body 5 when the wrench body 5 of the magnetic socket wrench assembly 4 is sleeved on the nut 8, so that the nut 8 can be disposed in direct contact with the magnets 9 in the mounting member 6. As the nut 8 is gradually and rotatably removed from the bolt 81, the shank portion of the bolt 81 correspondingly and gradually separates from the hole 63 in the mounting member 6. Since the nut 8 is magnetically attached to the magnets 9 in the mounting member 6, it is unlikely that the nut 8 will drop from the mounting member 6. Thus, the nut 8 can be easily removed from the bolt 81 having the long threaded shank portion.

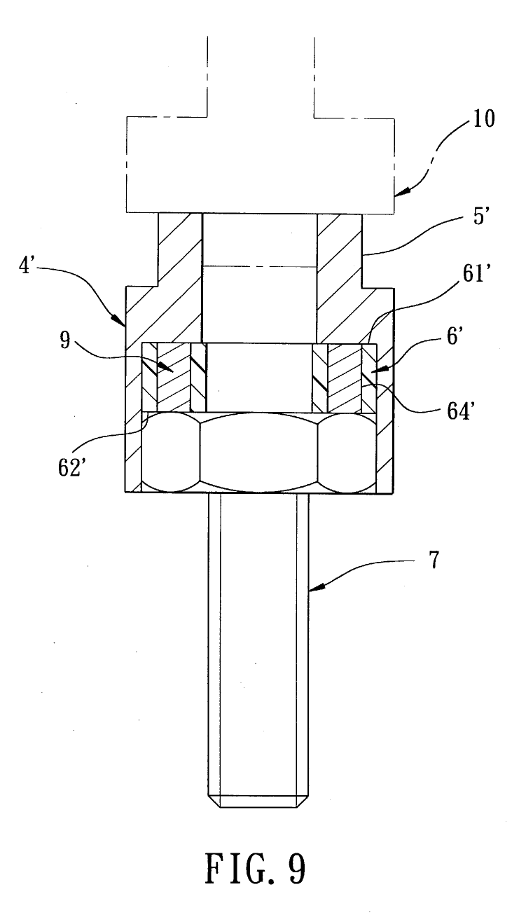

Referring to FIG. 9, the second preferred embodiment of the magnetic socket wrench assembly 4′ according to the present invention is shown to be substantially similar to the first preferred embodiment. However, in this embodiment, each of the magnet-receiving holes 64′ in the mounting member 6′ extends through the mounting member 6′. Use of the second preferred embodiment is substantially similar to the first preferred embodiment. Particularly, after the magnetic socket wrench assembly 4′ is connected to the tool 10, the wrench body 5 can be sleeved on a head portion of the screw bolt 7 to proceed with the fastening or removal of the screw bolt 7.

From the above description of the first and second preferred embodiments of the magnetic socket wrench assembly 4 of the present invention, it is apparent that since the long shank portion of the bolt 81 that engages the nut 8 can extend through the hole 63 in the mounting member 6 and into the narrow hole portion 531 of the central hole 53 in the wrench body 5, direct contact between the nut 8 and the magnets 9 can be ensured to attach magnetically the nut 8 to the mounting member 6. Furthermore, the structure of the magnetic socket wrench assembly 4 is relatively simple. The object of the present invention is accordingly achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A magnetic socket wrench assembly adapted to be connected removably to a tool for rotating a nut on a bolt, said socket wrench assembly comprising:
a tubular wrench body adapted to be connected to the tool and having a central hole that includes a shank-receiving narrow hole portion adapted for extension of a shank of the bolt thereinto, and a socket-defining wide hole portion, which is wider than said narrow hole portion, which is adapted to engage the nut, and which defines a shoulder between said narrow and wide hole portions;
an annular mounting member disposed fixedly in said wide hole portion of said central hole in said wrench body and abutting against said shoulder, said mounting member having a central hole formed therethrough and adapted for extension of the shank of the bolt therethrough, and a nut-engaging end surface which is adapted to abut against the nut and which is formed with a magnet-receiving hole unit therein; and
a magnet unit disposed in said hole unit in said mounting member and adapted for magnetically attracting the nut.

2. The magnetic socket wrench assembly of claim 1, wherein said mounting member is made of a non-magnetic, compressible material, and further has a tapered annular outer surface that has a maximum size slightly greater than that of said wide hole portion of said central hole in said wrench body and that has a minimum size slightly smaller than that of said wide hole portion of said central hole in said wrench body so that said mounting member can be press-fitted within said wide hole portion of said central hole in said wrench body.

3. The magnetic socket wrench assembly of claim 1, wherein each of said magnet-receiving holes in said mounting member has a closed end, each of said magnets having an inner end surface that is disposed at said closed end of a respective one of said magnet-receiving holes, and an outer end surface that is flush with said nut-engaging end surface of said mounting member.

4. The magnetic socket wrench assembly of claim 1, wherein each of said magnet-receiving holes in said mounting member extends through said mounting member.

5. The magnetic socket wrench assembly of claim 1, wherein said magnet-receiving hole unit includes a plurality of magnet-receiving holes, said magnet unit including a plurality of magnets disposed respectively in said holes in said mounting member and adapted for magnetically attracting the nut.
